(19) United States
(12) Patent Application Publication
(10) Pub. No.: US 2025/0386320 A1
(43) Pub. Date: Dec. 18, 2025

(54) Determining a Position of a Mobile Device Relative to a Vehicle

(71) Applicant: Bayerische Motoren Werke Aktiengesellschaft, Muenchen (DE)

(72) Inventors: Thorsten KNOTT, Tuntenhausen (DE); Alaa MOURAD, Muenchen (DE)

(21) Appl. No.: 19/239,614

(22) Filed: Jun. 16, 2025

(30) Foreign Application Priority Data
Jun. 17, 2024 (DE) 10 2024 116 958.3

(51) Int. Cl. H04W 64/00; H04W 4/40; H04W 4/80; H04W 76/10

(52) U.S. Cl. CPC H04W 64/00; H04W 4/40; H04W 4/80; H04W 76/10

(57) ABSTRACT

A method for determining the position of a mobile device relative to a vehicle includes establishing a wireless connection between the mobile device and the vehicle. A distance between the vehicle and the mobile device is determined based on a transmission time of a signal over the connection. The vehicle contains several transceivers mounted at different positions on the vehicle and the distance is determined successively relative to different transceivers. The position of the mobile device is determined based on the positions of the transceivers and the associated distances.

### CROSS REFERENCE TO RELATED APPLICATION

This application claims priority under 35 U.S.C. § 119 from German Patent Application No. DE 10 2024 116 958.3, filed Jun. 17, 2024, the entire disclosure of which is herein expressly incorporated by reference.

### BACKGROUND AND SUMMARY

The present invention relates to the wireless determination of a position of a mobile device relative to a vehicle.

A vehicle is equipped with a control device that is set up to control a security function of the vehicle. In particular, the security function can prevent the use of the vehicle by an unauthorized person. For example, the security function includes a central locking system or an immobilizer. The security function can be controlled by a mobile device that can communicate with the control device via a wireless connection. To prevent unauthorized control and make it more difficult to attack the system, the security function can only be controlled when the mobile device is within a predetermined range relative to the vehicle. This range is usually much smaller than the range of a wireless technology used for the connection. For example, the control of the security function can be denied if the mobile device is located further than approx. 3-5 m away from the vehicle.

A different radio technology is usually used to determine the position than for communication. For example, position determination can be carried out using ultra-wide band (UWB), which works similarly to an imaging radar system. Communication, on the other hand, can take place via a narrower band connection, such as Bluetooth. However, supporting different wireless technologies on both sides can be time-consuming and therefore cost intensive.

One of the underlying objects of the present invention is to provide an improved technique for determining a position of a mobile device relative to a vehicle. The invention achieves this object by means of the subject-matter described herein.

According to a first aspect of the present invention, a method for determining the position of a mobile device relative to a vehicle includes steps of establishing a wireless connection between the mobile device and the vehicle; determining a distance between the vehicle and the mobile device on the basis of a transmission time of a signal over the connection; wherein the vehicle contains several transceivers which are mounted at different positions on the vehicle, and the distance is determined sequentially relative to different transceivers; and determining the position based on the positions of the transceivers and the associated distances.

Position determination between a vehicle transceiver and multiple transceivers on the mobile device is usually not accurate enough, as the transceivers on the mobile device may not be spaced far enough apart. The determination of distances according to the proposed method also starts from the vehicle, so that the determined relative position of the mobile device is trustworthy for the vehicle.

The mobile device can communicate with the vehicle through the different transceivers one after the other, without having to take into account the change of the transceiver used. Thus, a common mobile device can be used for the technique proposed herein without modification. A mobile device that only allows a single connection at a time can also be used.

The connection is preferably established via Bluetooth. The connection can be classic Bluetooth (BT) or Bluetooth Low Energy (BLE). Distance determination between two communication partners has been possible for some time and is included in the standard from specification 6.0 onwards. Bluetooth can offer relatively high transmission rates and support a connection over a distance of tens to several hundred meters.

An identification of the vehicle in terms of the connection can be the same for all transceivers. This allows the connection to be seamlessly transferred from one transceiver to another. A connection layer can completely hide such a transition from a higher-level communication layer. In practice, this means that even parallel communication can be continued over the connection without interruption.

Connection parameters of the connection of a first transceiver used are preferably used by a transceiver that is used afterwards. If the connection includes a negotiated parameter, such as a degree of amplification or an identification of the vehicle (resolvable private address, RPA), or if the first transceiver has determined a connection parameter, such as a signal-to-noise ratio (SNR), the parameter can be adopted by the transceiver that is used later and reused. A parameter that does not change during communication can be provided from the first transceiver to all subsequent transceivers. Alternatively, a chain-like transfer of a parameter is possible.

Due to the limited size of the vehicle and the expected similar conditions when communicating via different transceivers, these parameters can at least represent sufficiently good approximations that can be used to continue communication. Optionally, a parameter can be adapted to prevailing conditions in the course of communication.

It is preferable that the distance is determined by means of channel sounding. Compared to a determination based on a signal strength or an SNR, a much better accuracy can be achieved. Channel sounding is based on determining the travel time of a signal between the communication partners and can provide accuracy in the range of a few centimeters.

Further preferably, the signal is emitted by the vehicle and reflected by the mobile device. In this way, two transit times can be determined, each of which indicates the distance of the mobile device from the vehicle or the transceiver currently being used.

If it is determined that the mobile device is within a predetermined range relative to the vehicle, a predetermined security function of the vehicle can be controlled via the connection. The range can extend to a predetermined distance from the vehicle, for example approx. 2-3 meters. The security function may allow a user of the mobile device to use the vehicle. For example, the security function can unlock or open a door or flap of the vehicle. In addition, an immobilizer or an alarm system of the vehicle can be deactivated.

Controlling the security function may involve authenticating the mobile device to the vehicle. Authentication is preferably carried out on the basis of an asymmetric cryptographic method. It is also preferable to authenticate the vehicle to the mobile device. Both authentications can take place within a predetermined exchange.

It is particularly preferable that authentication is based on a digital vehicle key stored on the mobile device. The security function can be controlled in particular on the basis of the proposals of the Car Connectivity Consortium. These proposals are laid down in a technical specification published under the name “Digital Key Release 3”. The technology described herein may be used in combination with the mentioned specification, wherein a position determination of the mobile device relative to a vehicle by UWB may be supplemented or replaced by the position determination by BT or BLE proposed herein.

According to a further aspect of the present invention, a device for a vehicle contains several transceivers mounted at different positions of the vehicle and set up to establish a wireless connection with a mobile device; and a processing device. The processing device is set up to determine distances between the vehicle and the transceivers on the basis of transmission times of signals over the connections; and to determine a position of the mobile device relative to the vehicle based on the positions of the transceivers and the associated distances.

The determined position can be used as a basis for controlling a security function of the vehicle. The device may be integrated with a control device for controlling a security function of the vehicle. The device may communicate with the mobile device on behalf of the vehicle, so that communication between the mobile device and the vehicle referred to herein may be realized in the form of communication between the mobile device and the device.

According to yet another aspect of the present invention, a vehicle contains a device described herein. The vehicle preferably consists of a motor vehicle. Furthermore, the vehicle preferably consists of a motorcycle or a passenger car. In other embodiments, the vehicle can also consist of a truck or a bus, for example.

The device, and in particular a processing device included therein, is preferably set up to carry out a method described herein in part or in full. For this purpose, the processing device can be implemented electronically and may contain, for example, an integrated circuit, a programmable logic device or a programmable microcomputer. The method can be implemented in the form of a configuration or as a computer program product with program code means for the processing device. The configuration or the computer program product may be stored on a computer-readable data carrier. Features or advantages of the method can be transferred to the device or vice versa.

According to another aspect of the present invention, a system contains a device described herein and a mobile device. In particular, the mobile device may consist of a personal device associated with a predetermined person. For example, the mobile device may consist of a smartphone, a smart watch, a smart band, another wearable, or a head mounted device. Alternatively, a stand-alone device (fob) can also be used. The mobile device also preferably contains a secure memory in which a digital vehicle key is stored. To access the vehicle key, for example to authenticate the mobile device to the vehicle, the user can authenticate themself to the mobile device. To do this, they can, for example, present a biometric feature or enter a predetermined secret. In a further embodiment, the system may also consist of a vehicle with a device described herein.

The invention is now described in more detail with reference to the accompanying drawings.

Other objects, advantages and novel features of the present invention will become apparent from the following detailed description when considered in conjunction with the accompanying drawings.

### BRIEF DESCRIPTION OF THE DRAWINGS

FIG. 1 illustrates a system; and

FIG. 2 illustrates a flow chart of a method.

### DETAILED DESCRIPTION OF THE DRAWINGS

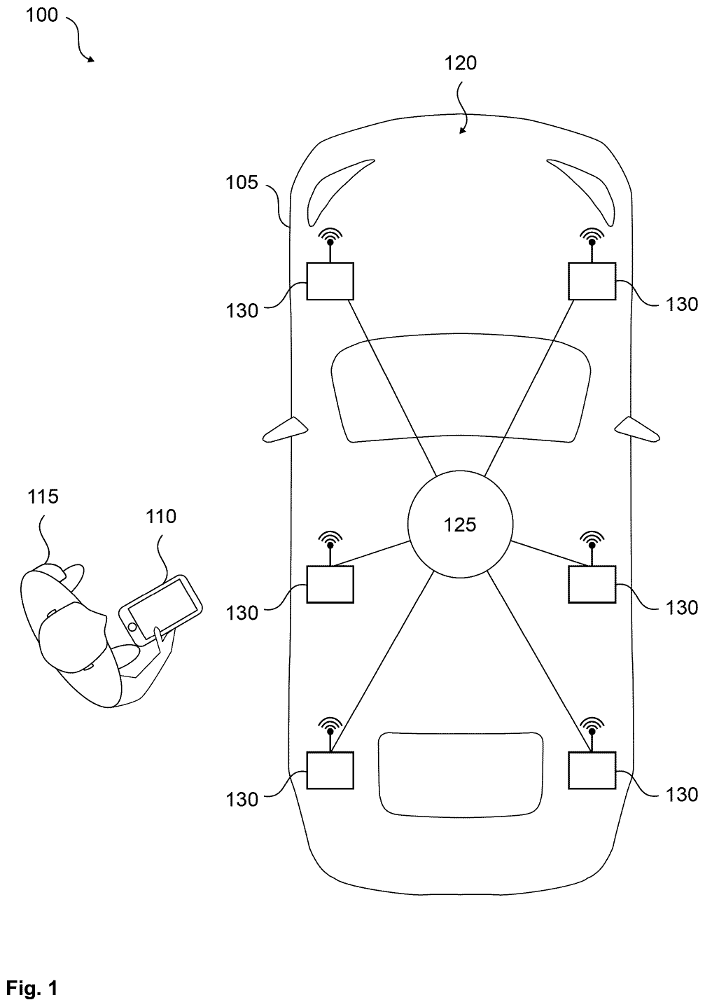

FIG. 1 shows a system 100 that contains a vehicle 105 and a mobile device 110. The mobile device 110 is implemented as a smartphone for instance and is associated with a user 115. The mobile device 110 contains a secure memory (trusted platform module, TPM) in which a digital vehicle key of the user 115 for the vehicle 105 is stored. The full vehicle key can include a private part and a public part, with at least the private part stored in the secure memory. The two parts can be used to perform an asymmetric cryptographic process.

The vehicle 105 has a device 120 that is set up to communicate with the mobile device 110 and to control a security function of the vehicle 105. For example, the security function may include opening a central locking system. The control of the security function requires authentication of the mobile device 110, which can be handled via a wireless connection between the mobile device 110 and the device 120. In this context, mutual authentication between the mobile device 110 and the device 120 is more preferably carried out within the framework of a standard transaction according to the CCC proposals (see Digital Key Release 3, Chapter 7).

The device 120 contains a processing device 125 and several transceivers 130. A transceiver (transmitter/receiver) is formed as a wireless transmitter and receiver unit. The transceivers 130 preferably works according to the specifications of BT or BLE. The transceivers 130 are mounted on the vehicle 105 at a distance from each other, and their relative positions or their positions relative to the vehicle 105 are preferably known. In the embodiment shown, one transceiver 130 is located in a front left area, one in a front right area, one in a rear left area and one in a rear right area of the vehicle 105. In addition, one optional transceiver 130 is mounted at the center left and one at the center right. Further or different positions are also possible, for example in the middle of the vehicle 105, for example in the area near an interior mirror.

To control the security function, the device 120 can determine whether the mobile device 110 is located within a predetermined range relative to the vehicle 105. If this is not the case, the control or even the authentication can be rejected.

To determine the position, distances between the mobile device 110 and the transceivers 130 can be determined. For this purpose, it is proposed that the device 120 first establishes a wireless connection with the mobile device by means of any of the transceivers 130. In one embodiment, only one of the transceivers 130 can initially be activated to indicate that the device 120 is ready to connect (advertising).

Once the wireless connection between the mobile device 110 and the device 120 has been established, parameters of the connection can be provided from the active transceiver 130 to one or more of the other transceivers 130. By means of the active transceiver 130, a distance measurement to the mobile device 110 can be determined preferably by means of channel sounding. After that, the connection can be passed to one of the remaining transceivers 130 and a new distance determination can be made. This can be continued until a distance to the mobile device 110 has been determined for several, ideally all, transceivers 130.

The determined distances, along with the positions of the transceivers 130, can be used to determine the relative position of the mobile device. A triangulation method can be used for this purpose. The position can be determined in such a way that the distances match the determined position as closely as possible and possible measurement or determination errors are minimized. If it can be assumed that the mobile device 110 is located at a predetermined height above a ground, its position can already be determined on the basis of two distances to transceivers 130, as long as the mobile device 110 and the transceivers 130 are not in a line, so that the determinations are independent of each other. If the position of the mobile device 110 in space is not further restricted, it can be determined on the basis of at least three independent distance measurements.

In general, for geometrical reasons, the more independent distances to transceivers 130 are determined, the more precisely the position can be determined. More precisely, the geometrically determined accuracy of the position determination can be proportional to the volume of a polyhedron spanned by the mobile device 110 and the transceivers 130 (cf. geometric dilution of precision).

Now it can be determined whether the determined relative position is within a predetermined range with respect to the vehicle 105—or the configuration of transceivers 130. If this is the case, the mobile device 110 can be authenticated to the device 120 and a request to control a predetermined security function can be submitted to the device 120. Communication required for the authentication can be handled via the wireless connection that has already been established.

If the authentication is successful and the vehicle key used for authentication is authorized to control the function, the requested function can be controlled on the vehicle 105.

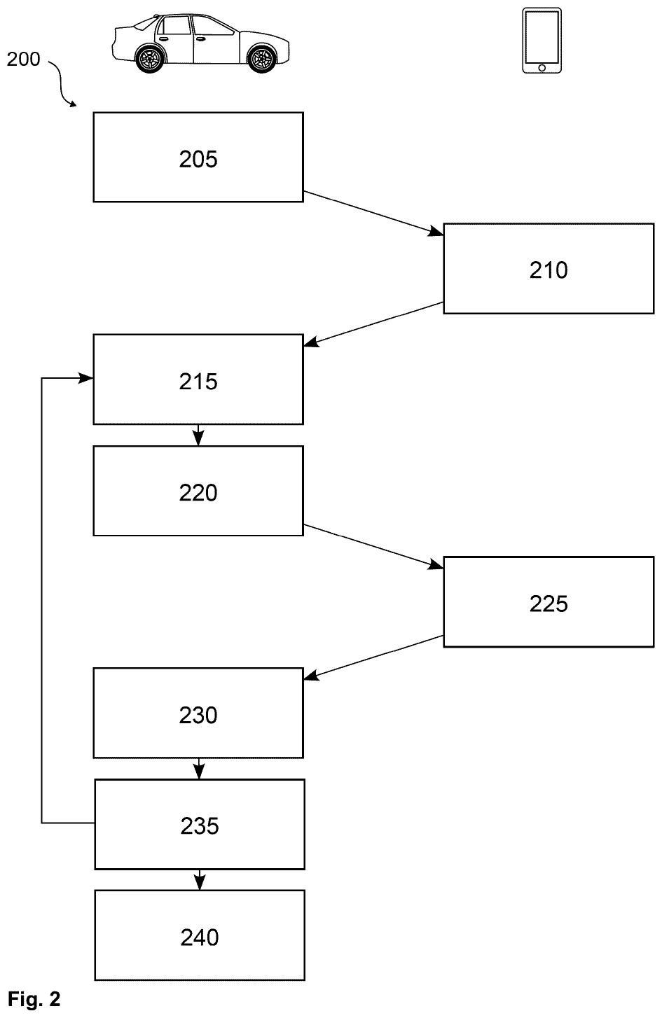

FIG. 2 shows a flow chart of a method 200 for controlling a security function of the vehicle 105 by means of a mobile device 110. The method 200 can be carried out in particular by means of a system 100. For easier understanding, steps are shown in a left area that are more likely to be associated with the vehicle 105 and in a right area steps that are more likely to be associated with the mobile device 110.

In a step 205, the vehicle 105, i.e., the device 110, can signal a readiness for connection via one of the transceivers 130. Optionally, the readiness for connection can also be signaled via several of the transceivers 130, or different transceivers 130 can be used one after the other to signal readiness for connection. For signaling, a corresponding message can be sent out periodically on a predetermined frequency.

If the mobile device 110 approaches the vehicle 105, it will eventually come within communication range of the device 110 and can receive the readiness for connection message. The mobile device 110 can compare a station identifier of the device 120 with a predetermined station identifier associated with the vehicle 105. If the identifiers coincide, a wireless connection can be established between the mobile device 110 and the device 120 on board the vehicle 105 in a step 210. For this purpose, single-sided or two-sided authentication can be carried out. The connection preferably works according to the BT or BLE standard and authentication can be carried out according to this standard. Once the connection has been established, any data can be exchanged between the vehicle 105 and the mobile device 110.

In a step 215, one of the transceivers 130 on the vehicle 105 is selected for communication. In one embodiment, the transceiver 130 that was used to establish the wireless connection is first selected.

In a step 220, a distance determination by channel sounding can be started. For this purpose, a predetermined signal can be transmitted from the device 120 to the mobile device 110 via the selected transceiver 130. The mobile device 110 can receive the signal and send it back to the device 120 in a step 225. In one embodiment, a distance is determined for each transmission, in another the distance is determined on the basis of a round-trip duration.

In a step 230, the distance to the selected transceiver 130 can be determined by the device 120. The determined distance can be associated with a position of the transceiver 130. In a step 235, another transceiver 130 can be selected and the wireless connection to the mobile device 110 can be continued using this transceiver 130. For this purpose, a connection parameter from the last transceiver 130 used can be adopted by the newly selected transceiver 130.

Steps 215 to 235 can be looped through several times until a distance has been determined using all available transceivers 130. In a step 240, a position of the mobile device 110 relative to the transceivers 130 can then be determined on the basis of the positions of the transceivers 130 and the determined distances associated with them.

Optionally, it can also be decided whether the determined position is within a predetermined range of the vehicle 105. If this is the case, authentication can be carried out between the mobile device 110 and the device 120 via the wireless connection. The authentication may include a requirement to control a predetermined security function of the vehicle 105. If all the requirements for controlling the security function of the vehicle 105 are met, the security function can be controlled.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 System
105 Vehicle
110 Mobile device
115 User
120 Device
125 Processing device
130 Transceiver
200 Method
205 Signaling readiness to connect
210 Establish a connection
215 Using Transceiver i
220 Sending a signal
225 Reflecting the signal
230 Determining distance i
235 Selecting the next transceiver
240 Determining position

What is claimed is:

1. A method for determining the position of a mobile device relative to a vehicle, the method comprising:
establishing a wireless connection between the mobile device and the vehicle;
determining a distance between the vehicle and the mobile device on the basis of a transmission time of a signal over the connection, wherein the vehicle contains several transceivers mounted at different positions on the vehicle and the distance is determined successively relative to different transceivers; and
determining the position based on the positions of the transceivers and the associated distances.

2. The method of claim 1, wherein the connection is established via Bluetooth.

3. The method of claim 1, wherein an identification of the vehicle with respect to the connection is the same for all transceivers.

4. The method of claim 1, wherein connection parameters of the connection from a first transceiver used are used by a transceiver that is used thereafter.

5. The method of claim 1, wherein the distance is determined by channel sounding.

6. The method of claim 1, wherein the signal is emitted by the vehicle and reflected by the mobile device.

7. The method of claim 1,
wherein it is determined that the mobile device is within a predetermined range relative to the vehicle; and
wherein a predetermined security function of the vehicle is controlled via the connection.

8. The method of claim 7, wherein the mobile device is authenticated to the vehicle.

9. The method of claim 8, wherein the authentication is carried out based on a digital vehicle key stored on the mobile device.

10. A device for a vehicle, comprising:
several transceivers mounted at different positions of the vehicle and configured to establish a wireless connection with a mobile device; and
a processing device configured to:
determine distances between the vehicle and the transceivers on the basis of transmission times of signals over the connections, and
determine a position of the mobile device relative to the vehicle based on the positions of the transceivers and the associated distances.

11. A vehicle, comprising the device of claim 10.

12. A system, comprising the device of claim 10 and a mobile device.
